(19) United States
(12) Patent Application Publication
(10) Pub. No.: US 2010/0285952 A1
(43) Pub. Date: Nov. 11, 2010

(54) Process for Producing Finely Divided, High-Surface-Area Materials Coated with Inorganic Nanoparticles, and also Use Thereof

(75) Inventors: Jürgen Hofinger, Dresden (AT); Daniela Keck, Dresden (DE); Steffen Roos, Dresden (DE); Kevin Zirpel, Dresden (DE)

Correspondence Address: GUDRUN E. HUCKETT DRAUDT, SCHUBERTSTR. 15A, WUPPERTAL, 42289, DE

(73) Assignee: NAMOS GMBH, Dresden (DE)

(21) Appl. No.: 12/671,221

(22) PCT Filed: Jul. 31, 2008
(86) PCT No.: PCT/EP2008/060105

§ 371 Date: Jul. 22, 2010

(30) Foreign Application Priority Data
Jul. 31, 2007 (DE) 10 2007 037 200.2

(51) Int. Cl. B01J 31/06; B01J 32/00

(52) U.S. Cl. 502/159; 502/439; 977/773

(57) ABSTRACT

The invention relates to a process for producing finely divided high-surface-area materials coated with inorganic nanoparticles, and also the materials produced thereby, in particular catalysts for heterogeneous catalysis. The process according to the invention is characterized in that the finely divided high-surface-area material is contacted with a suspension of inorganic nanoparticles in a liquid medium in which the nanoparticles are bound to biopolymers, and in that, if appropriate, the catalytically coated finely divided high-surface-area material is dried.

The invention concerns a method for producing finely divided, high-surface area materials coated with inorganic nanoparticles as well as materials produced thereby, especially catalyst for heterogeneous catalysis.

The preparation of metallic particles by precipitation from a solution is known and is used industrially on a large scale. Precipitation is triggered, for example, by reduction through the addition of reducing agents. This leads to homogeneous nucleation of metallic dusters in solution. Characteristic for this type of particle synthesis is the formation of large particles as well as a great spread of the particle size because the formation of the particles takes place at different times and, upon surpassing a critical particle diameter, further growth is energetically favored in comparison to the generation of new particles. Moreover, without further additives agglomeration of the particles takes place that may advance to the point of complete spatial separation of the metal from the solution.

The large demand for small metallic particles with a narrow size distribution in a stable suspension has lead to numerous developments.

In the simplest case particles are synthesized homogeneously in solution with very minimal concentration of the components to be precipitated. As a result of the large distances of the generated particles the latter are relatively stable in solution. This is achieved via precipitation reaction without nucleating agent. Under suitable reaction conditions the particle size is limited downwardly by increased dissolution pressure of small particles that will dissolve in favor of larger particles and in the upward direction by dropping below the critical concentration in the solution required for further growth.

Depending on the method, in this way particle suspensions, partially with very narrow size distribution, can be produced. The methods moreover are generally very simple and inexpensive. However, the preparation is realized in general in minimal concentrations in order to prevent coagulation of the particles.

A special embodiment of this method is disclosed in DE 10 2005 048 201 A1. Here, in a microreactor the spatial and temporal course of the particle generation is affected. In this way, the growth of larger particles can be prevented by an appropriate control of the concentration of the reactants. Already formed metal particles serve as nucleation centers for further depositions and effect further growth. The higher the concentration of possible nucleation centers, the smaller and more numerous the resulting particles. This leads to an improvement of the size distribution of the nanoparticles.

In many publications a method for producing particles of only a few nanometers in size with a narrow size distribution by means of stabilizers is disclosed also (e.g. Rampino et al., J. Am. Soc, 63, 2745-2749, 1942; Petroski et al., J. Phys Chem. A, 105, 5542-5547, 2001; Tang et al., J. Coll. Interfaces, 287, 159-166, 2005). With a suitable addition of growth inhibitors, for example, water-soluble polymers (polyvinyl alcohol, polyvinyl pyrrolidone, gelatin) or surface active agents the particle growth is stopped at an early stage. These additives that are referred to as “capping agents” moreover prevent as a protective colloid the agglomeration of the particles.

In optimized methods the task of the capping agent is even reduced only to that of the protective colloid. In this case, the solution is completely used up in favor of the resulting particles. This is however difficult with respect to technical aspects of the method especially in case of higher concentrations of the particles in solution. In most cases, in this method no protection against agglomeration exists in the growth phase of the particles so that the enabled directly producible particle concentration is limited.

General knowledge in the art is the preparation of nanoparticles on surfaces. In this method, firstly metallic salts are bonded in continuous layers to the substrate surface. After a precipitation process particles are formed whose size and distribution depend on the process control as well as the interaction with the substrate. Local inhomogeneities that cannot be avoided completely therefore cause fluctuations in the particle size as well as in the distribution of the particles (dispersion).

A known example for heterogeneous nucleation is silver staining in protein analysis on an electrophoresis gel (e.g. Blum et al., Electrophoresis 8, 93-99, 1987). In this connection proteins are separated in a gel and silver ions are bonded to various side groups of the proteins. After addition of a reducing agent nanoclusters are formed that mark the protein bands by brown stains.

WO2004/033488A2 discloses the synthesis of nanoparticles by means of a specific bond of special biotemplates (phage peptides) with a gene-technologically matched metal-binding region (MBR). For each type of particle, special biotemplates must be selected by biopanning that enable subsequently highly specific synthesis of the nanoparticles. The preparation of the templates is however very complex because they first must be bonded in several steps to conventionally produced nanoparticles and by means of genetic amplification must be produced in a sufficient quantity by biotechnological means. The selected peptides do not occupy like growth inhibitors the entire surface area of the particles and have a length of 7 or 12 amino acid residues. For this reason, the agglomeration of the nanoparticles cannot be prevented.

DE19624332A1 discloses a metallic nanostructure on the basis of self-organizing proteins. The employed biomolecules represent templates in this context that are either occupied by individual metallic particles or coated with closed metallic layers. The shape of the particles, but also substantially their size, are determined thus by the templates. As examples in DE 19624332A1 tubular microtubuli and flat S-layers are mentioned.

A special variant of the nanopartide synthesis on the basis of biological templates is the use of DNA molecules. In this connection, appropriately prepared nucleic acids in solution or also adsorbed on surfaces and subjected to a chemical metal coating step. The nucleic acids represent thus the template for the nucleation and the growth of metallic particles and layers. In this connection, the templates are also shape-determining and substantially also size-determining and enable production of thread-shaped nanopartides with very large aspect ratio. Due to the method, on one of these templates either several particles are deposited (e.g. EP 1 283 526 A1 or Pompe et al. Z. Metallk. 90 (1999)) that more or less envelope the template externally, or a direct metallization of the template without formation of clusters occurs (e.g. EP 1 209 695 A1). Since the metallization is located on the exterior side of the entire biomolecule, in both cases no protection against agglomeration of the particles is provided by the template.

EP 1 666 177 A1 discloses a precious metal colloid that by reduction of a metal oxide solution is produced on a biomolecule in basic solution. The formation of the metallic particles is realized directly on the biomolecule so that at the same time an agglomeration of the particles is prevented. Since the biocomponent is utilized as reducing agent in a basic environment, exclusively metallic particles are produced however. A further use of the biocomponent in connection with the formation of nanostructures or the precipitation on surfaces is not disclosed.

WO2006053225 discloses the generation of nanoparticles of silver in suspensions by functionalizing BSA (bovine serum albumin) molecules. The method comprises the chemical reduction of an ionic metal precursor at room temperature in an aqueous solution. At a suitable pH value disulfide bonds between the proteins and the precious metals are formed. The protein is thus a nucleation agent and stabilizes the metallic nanoparticles at the same time against agglomeration. Especially advantageous in this method is that the thus formed nanoparticles are not completely coated by the stabilizing components and are therefore relatively freely accessible for reactions. However, the formation of nanostructures on surfaces is also not disclosed herein.

Metallic nanostructures and nanostructures consisting of metal salts on the surface of support materials are still required for various applications, for example, for coating honeycomb bodies for exhaust gas catalysts (washcoats), anode and cathode catalysts in fuel cells, particle filters, for example, soot particle filters, and catalyst coated membranes in PEM (proton exchange membranes) electrolytic devices.

In this connection, important properties are in general a high reproducibility of the manufacturing method, a narrow and, if possible, adjustable particle size distribution as well as a distribution (dispersion) as uniform as possible on the support material. A disadvantage of all known methods is that greater quantities of the particles with these properties cannot be produced with methods that are sufficiently cost-efficient. This holds true in particular for the use of nanoparticles in industrial methods, for example, the manufacture of catalysts on supports.

Catalysts on supports are comprised usually of metallic or ceramic honeycomb bodies that are coated by immersion coating methods with finely divided high-surface area carrier materials, for example, ceramic powders (washcoat). These carrier materials are either before or after coating loaded with the catalytically active metals that are to be distributed as homogeneously as possible and in the form of nanoparticles on the surface of the powder particles.

When employing suspensions in which the nanoparticles are already formed before loading of the support material, the agglomeration of individual nanoparticles must be prevented by means of additives. According to the prior art, in this connection surface functionalizations are employed (“capping agents”) that, however, may impair the catalytic activity. In particular, at higher temperatures during use of some catalysts compounds can be produced that are disadvantageous for the activity. Moreover, such chemical synthesis processes are not realizable or only with great cost expenditure on a large technical scale. Finally, the change of the surface of the particles can negatively influence the dispersion on the carrier materials.

The nanoparticle suspensions produced according to the prior art are stable only at minimal particle concentrations (0.016 g/l-0.2 g/l) because the attractive interaction of the particles dominates and leads to agglomeration and as a result of this to precipitation in the solution. Moreover, currently known chemical synthesis methods for producing nanoparticles in solution in comparison to simple precipitation of the particles on surfaces of support materials are relatively expensive and complex especially on a large technical scale.

It is therefore an object of the invention to provide a method that is as simple as possible and inexpensive for producing metallic nanostructures and/or nanostructures comprised of metal salts on surfaces of finely divided, high-surface area materials, wherein according to the method first a suspension of inorganic nanoparticles is generated in high concentration without forming agglomerates and, because of this, the nanoparticles are distributed as uniformly as possible on surfaces of the finely divided, high-surface area materials.

The object is solved by a method for producing finely divided, high-surface area materials coated with inorganic nanoparticles. In this connection, the finely divided, high-surface area material is contacted with a suspension of inorganic nanoparticles in a liquid medium in which suspension the nanoparticles are bonded to biopolymers. Optionally, the thus coated finely divided, high-surface area material is subsequently dried.

The suspensions that are employed in the method according to the invention contain inorganic nanopartides that are bonded to biopolymers and, in the following, are also referred to as biopolymer nanoparticle conjugates or conjugates.

These biopolymer nanoparticle conjugates are produced in that the biopolymers are incubated in a metal salt solution and, initially, nanopartides comprised of metal salts are generated on the biopolymers. Preferably, a metal salt solution is selected from aqueous AgNO₃, (CH₃COO)₂Pd, Pt(NO₃)₂, H₂(Pt(OH)₆, K₂PtCl₄ solutions or mixtures thereof. In order to advance subsequently from the metal salts to metallic nanoparticle conjugates, a reducing step must be performed. When doing so, the bond of the inorganic nanoparticle to the biopolymer remains intact.

According to an advantageous embodiment of the method according to the invention, a solution of an inorganic salt with a concentration of at least 1 mmol/l is incubated with 0.25% to 100% equivalents of a solution of a biopolymer with intensive mixing action.

From these nanoparticles of metal salts bonded to biopolymers metallic nanopartides are produced by reduction that however still are bonded to the biopolymers. In addition, free metal ions within the solution can be bonded to the seed produced accordingly and this leads to further growth of the metallic nanopartides.

As inorganic nanoparticles in the method according to the invention preferably metallic nanoparticles and/or nanopartides comprised of metal salts are used. According to the invention, the metal salts include also metal oxides. Preferably, the nanoparticles are comprised of an element or an element compound of the groups 3 to 12 of the periodic table of the elements or of mixtures or alloys of elements or element compounds of the groups 3 to 12 of the periodic table of the elements. Especially preferred are elements or element compounds of the platinum metal group such as Os, Ir, Pt, Ru, Rh and Pd or mixtures or alloys thereof. Preferably, the particles are comprised of platinum, palladium, gold, silver, nickel, cobalt, iron or their oxides or their salts.

For producing nanoparticles according to the present method, all elements of the main groups 3 to 12 and their salts can be employed. Preferred in this connection are the elements of the so-called heavy metals and their salts, for example, oxides, sulfides, carbonates, sulfates, phosphates, nitrates, chromates and permanganates. Especially preferred in this connection are the elements of the so-called precious metals, for example, Ru, Rh, Pd, Ag, Re, Os, Ir, Pt, Au, Hg, Tc, Ni, Cu, As, Sn, Sb, Bi and their salts, for example, Ru₃(O)₂(NH₃)₁₄]Cl₆.4 H₂O, (NH₄)₃[RhCl₆], [Pd(NO₃)₂], AgNO₃, NH₄ReO₄, OsO₂(NH₃)₄Cl₂, IrCl₃, H₂Pt(OH)₆, AuCl₃, Hg(NO₃)₂, Tc₂O₇, NiCl₂, CuSO₄, As₂O₃, Sn(SO₄)₂, Sb₂O₃, Bi₂S₃.

In a special embodiment, in this connection the elements of the so-called platinum metals and their salts are of great importance, as for example

| ruthenium | rhodium | palladium | osmium | iridium | platinum |
|---|---|---|---|---|---|
| (Ru) | (Rh) | (Pd) | (Os) | (Ir) | (Pt) |
| Ru₃(O)₂(NH₃)₁₄] | RhCl₃ * | [Pd(NO₃)₂] | OsO₄ | IrCl₃ | PtCl₄ |
| Cl₆•4 H₂O | 3H₂O | | | | |
| RuCl₃ * xH₂O | Rh(NO₃)₃ | Pd(Cl)₂ | OsO₂ | IrF₄ | H₂Pt(OH)₆ |
| | | | (NH₃)₄Cl₂ | | |
| RuO₂ * xH₂O | Rh(CH₃ | Pd(CH₃ | OsCl₃ | IrO₄ | PtO₃ |
| | COOH)₂ | COOH)₂ | | | |

The individual nanoparticles have a size smaller than 500 nm. Preferably the nanopartides have a particle size of 1 nm to 100 nm.

Advantageously, the inventively employed biopolymers initiate the nucleation of the nanoparticles without causing accumulation of competing seeds. At the same time, the biopolymers stabilize the suspension according to the invention and prevent agglomeration of the particles.

With the suspension according to the invention it is thus advantageously possible to provide a very high concentration of the nanoparticles. The nanoparticles are present in the suspension in a concentration of at least 0.25 g/l. At the same time, the suspension according to the invention is almost free of agglomerates. Agglomerates are to be understood in this connection as particles with a diameter of greater than 100 nm. According to the synthesis of the present invention maximally 3% by weight of the nanoparticles exist in such agglomerates.

The suspension is stable for several months. Sedimentation of particles is not observed. Advantageously, stable nanoparticle suspensions can be produced that do not agglomerates.

When preparing metallic nanopartides in suspension preferably a reducing agent is employed. In this connection, NaBH₄ solution is preferred but also other reducing agents such as DMAB (dimethylamino borane) or hydrazinium hydrochloride (N₂H₅Cl) can be used.

The nanoparticles are bonded by unspecific bonds to the biopolymers in the thus produced suspension according to the invention. Advantageously, the biopolymers induce the formation of nanoparticles and act as stabilizers of the suspension. The latter is realized by inhibition of agglomeration or prevention of formation of crystals that are too large, i.e., the biopolymers initiate, on the one hand, the nucleation of the nanoparticles and prevent, on the other hand, bonding of the nanoparticles to one another.

Since bonding of the nanoparticles to the biopolymer is independent of the kind of the nanoparticles, the method according to the invention can be advantageously universally employed for producing highly concentrated suspension of inorganic nanoparticles of various kinds.

In that in the method according to the invention the formation of the nanopartides is spatially and temporally separated from the application onto the finely divided, high-surface area materials, the individual processes can be optimized better. In the conventional methods according to the prior art, for example, precipitation of catalytically active metallic nanoparticles on catalyst supports from a metal salt solution, problems result because the optimal conditions for the formation of the nanoparticles (for example, precipitation on the substrate) are not identical to the conditions for an optimal bonding of the nanopartides to the support materials. In the method according to the invention, the bonding of the conjugates to the finely divided, high-surface area materials can be advantageously optimized in that the nanoparticles are already preformed on the biopolymer. Moreover, bonding of defined particles is possible because the size of the nanoparticles is defined by the biopolymers upon generation from a salt solution and even upon precipitation and optionally subsequent reduction of the nanoparticles no further growth can occur.

For achieving a further increase of the concentration, the suspension of biopolymer nanopartide conjugates can advantageously be further concentrated.

In a preferred form of preparation the suspension is concentrated by ultrafiltration.

After producing a concentrated suspension of biopolymer nanoparticle conjugates for the method according to the invention, the suspension can be subjected to lyophilization or a drying process (for example, spray drying) in order to obtain a dry powder. This serves for concentration in order to achieve a greater surface loading. For coating the finely divided, high-surface area materials the conjugate powder is transferred again into a suspension by dissolving in a suitable solvent.

The suspensions of biopolymer nanoparticle conjugates according to the method of the invention are contacted with the finely divided, high-surface area materials so that the biopolymer nanoparticle conjugates bond to the finely divided, high-surface area material. This can be realized by spraying onto a dry or wetted and still flowable powder. Also, impregnation of a powder in the suspension is possible. For coating a powder a preferred form of contacting is an intensive mixing of the powder and slow addition of high concentrations of the suspension so that a distribution of the precious metals on the powder as uniform as possible is realized.

By bonding the biopolymer nanoparticle conjugates to the finely divided, high-surface area materials, on the materials a coating with biopolymer nanoparticle conjugates is produced wherein this is not to be understood as a closed layer but a nanoscale structure on the surface of the finely divided, high-surface area material that is achieved by a uniform distribution of the individual nanoparticles or conjugates.

The finely divided high-surface area support materials are comprised of metallic, ceramic or polymer materials or materials of carbon (for example, active carbon). Especially preferred are support materials of aluminum oxides, aluminum silicates, zeolites, silicon dioxide, titanium oxide, zirconium oxide or cerium oxide or mixtures or mixed oxides. The employed support materials are preferably finely divided, i.e., they have an open mesoporosity or microporosity with a pore size of 1 to 50 nm and/or have a surface roughness for which either the wavelength or the depth of the surface structure is in the range of 1 to 100 nm.

Alternatively, the surface of the finely divided, high-surface area material can also be characterized by providing the BET values for nitrogen. For example, a suitable aluminum oxide powder has a specific surface area of greater than 150, preferably greater than 250 m²/g.

The corresponding high-surface area support materials can be present as particles, as bulk material or as a coating.

According to a further preferred embodiment of the method according to the invention the surfaces of the finely divided, high-surface area materials are conditioned by a pretreatment in order to increase bonding of the subsequently deposited conjugates on the surfaces.

The bonding of the nanopartides on the biopolymers enables the electrostatic or covalent coupling of the conjugates on the surfaces of the finely divided, high-surface area materials. In this connection, standard methods for cross-linking of proteins can be used. This can be realized by a suitable pretreatment either of the finely divided surfaces or the conjugates.

One example for the electrostatic coupling is silanization or silicate coating or the use of polyelectrolytes. Covalent coupling can be achieved, for example, by use of cross-linking agents such as EDC/NHS (1-ethyl-3-(3-dimethylamino propyl))carbodiimide, N-hydroxysuccinimide), HDI (hexamethyl diisocyanate) or glutaric aldehyde.

A special embodiment is the combination of electrostatic and covalent coupling, in which, for example, an electrostatically acting silanization enables coupling by covalently binding groups. For this purpose, for example, in case of ceramic materials, on the surface a polysiloxane network is deposited which is suitable for covalent coupling of the nanopartide conjugates on the support. Preferably, for this purpose the material is incubated with 10% APTES (3-aminopropyl triethoxy silane in acetone).

A further preferred embodiment concerns the coating of the nanoparticles present in the suspension with porous materials, for example, with a thin silicon layer that also can increase bonding to the substrate surface. Moreover, the coating after precipitation represents a sintering barrier at higher temperatures as they occur, for example, when used in exhaust gas catalysts. At higher temperatures, often an enlargement of the precipitated particles (sintering) occurs that is inhibited by the coating.

When performing the method according to the invention with a suspension of nanoparticles comprised of metal salts that has been produced by means of proteins in solution, there are various ways to arrive at the metallic nanoparticles dispersed on the finely divided, high-surface area materials. In this connection, a reduction of the nanoparticles comprised of metal salts to metallic nanoparticles is necessary that may take place either before or after contacting of the conjugates with the finely divided, high-surface area materials.

When the reduction is to be carried out before coating of the finely divided, high-surface area materials, the nanoparticles comprised of metal salts and conjugated to the biopolymers are reduced in solution to metallic nanoparticles, for example, by addition of a reducing agent such as NaBH₄. For the method according to the invention, suspensions of metallic nanoparticles that are bonded to biopolymers are then used.

Preferably the reduction takes place not until the nanoparticle biopolymer conjugates comprised of metal salts have been deposited directly on the surfaces of the finely divided, high-surface area materials. In an especially preferred embodiment, the finely divided, high-surface area material is dried after coating and subsequently the nanoparticles comprised of metal salts and bonded thereto are reduced to metallic nanoparticles by dry reduction with hydrogen gas.

When the coated high-surface area finely divided material is used for catalysis, the reduction can also be performed during conditioning of the catalyst.

In an especially preferred embodiment, the thus produced metallic nanoparticles are produced by dry reduction with hydrogen at temperatures greater than 100° C.

The nanoparticles are generated on biopolymers by the method according to the invention. Biopolymers are high-molecular polymers that are produced by living organisms and are comprised of monomers such as monosaccharides, nucleotides or amino acids. Such biopolymers are, for example, proteins or nucleic acids. Preferably, as a biopolymer a globular protein or a globular folded peptide is used. According to an advantageous embodiment of the method according to the invention, the protein is selected from the family of albumins, such as human serum albumin (HSA), prealbumin, lactalbumin, conalbumin, ovalbumin, or parvalbumin, or from the family of the globulins, e.g. transferrin.

Preferably, the protein is a bovine serum albumin (BSA). Proteins in the context of this invention also encompass proteins and peptides that are modified naturally or artificially by non-protein proportions and/or have a modified backbone or artificial proteins, peptides or polymers analog thereto, for example, β-peptides.

In a further embodiment of the present invention, non-recrystallizable S-layer proteins are used. These are S-layer proteins that are modified such that they no longer arrange themselves in a self-organizing fashion but still advantageously have their metal-binding properties. As a result of the increased affinity to metal the efficiency of producing nanoparticles is advantageously increased and less concentrated metal salt solutions can be employed for producing the nanoparticles.

When using proteins as biopolymers, they have more than 20, preferably more than 100, in particular preferred 375 to 1,250 amino acid residues. The mass of the biopolymers employed according to the invention is 15 to 200 kD, preferably 15 to 150 kD, and particularly preferred 45 to 150 kD.

In a preferred embodiment, the biopolymers according to the invention are present in the suspension in a concentration of 0.017 g/l to 80 WI, particularly preferred in a concentration of 0.017 g/l to 40 g/l. Preferred, the isoelectric point of the biopolymer is at 3 to 6, particularly preferred at 4 to 5.

The biopolymers employed according to the invention have on their surface functional groups that can be utilized for binding inorganic molecules. In this way, during incubation of the biopolymers in a metal salt solution the metal salts are bonded to the biopolymers which leads to the formation of an inorganic nanoparticle bonded to the biopolymers. Bonding of the inorganic molecules on the biopolymer is preferably unspecific.

Number and density of the bonded inorganic molecules is such that by one biopolymer one particle is represented, respectively. By oligomerization and polymerization of the biopolymers to larger units moreover larger particles of several biopolymers can be formed. The task of the biopolymers according to the invention is therefore, on the one hand, to cause by localized bonding centers a concentration of inorganic molecules that are subsequently represented on the surfaces to be coated as individual particles without this requiring its own precipitation step for precipitation of the particles from the metal salt solution, for example, by changing the pH value.

On the other hand, under conditions in the suspension under which without stabilizing additives an agglomeration of the inorganic nanopartides would take place, these agglomerates are already prevented simply by means of the biopolymer. This stabilization through the biopolymers is particularly advantageous when already in solution a reduction is carried out and therefore metallic nanoparticles are present on the biopolymer.

In an especially preferred embodiment of the method according to the invention the metallic nanoparticles that are uniformly distributed on the surface of the metallic, ceramic or polymer materials are produced from metal salts that have been generated in a suspension on biopolymers and deposited on the support materials and that, subsequently, by environmental conditions that are incompatible for the biopolymers have been reduced to metallic nanopartides. In this connection, it is advantageous that simultaneously with the reduction of the metal salt nanoparticles to the metallic nanoparticles, the biopolymers that are required for generating the uniform distribution of the nanopartides on the surface are denatured.

In an especially preferred embodiment, the particles produced according to the invention are comprised of more than one metal or more than one metal salt wherein the various metals in the particle may be present as an alloy or mixed crystal or as a mixture of different particles of different materials.

The suspension that is employed for the method according to the invention can be used especially advantageously for producing such polymetallic nanoparticles. In the method according to the invention on the biopolymers nanopartides are produced that are comprised of a mixture of the metal salts of the solution. The production of nanoparticles of metal salts with defined ratios of the individual components is not possible with standard methods because the participating metal salts generally can be precipitated only at different pH values and thus not at the same time.

On the other hand, by binding a plurality of metal salt molecules on a biopolymer, particles of a mixture of metal salts can be formed without precipitation and remain on surfaces after coating and after reduction. A minimal specificity of the bonding mechanism on the biopolymer favors in this connection the adjustment of any ratio of different metal salts. Since each individual biopolymer leads to the formation of a particle or polymers of biopolymers lead to correspondingly larger particles, the adjusted ratio of the metal salts relative to one another in the solution, in contrast to the precipitation reactions of molecules, remains intact even after particle formation.

In the method according to the invention, on the biopolymers that are present in the suspension first nanoparticles of several metal salts are generated. By reduction from these nanoparticles metallic nanoparticles are produced which are comprised of several metals. Such nanoparticles can have preferred properties, for example, bimetallic nanoparticles of Pd and Pt are more sinter-stable and, for example, when used in exhaust gas catalysts, they lead a longer service life of the catalyst.

The invention comprises therefore also the use of suspensions of inorganic nanoparticles in a liquid medium, in which the nanoparticles are bonded to biopolymers, for producing finely divided, high-surface area materials coated with inorganic nanoparticles.

The invention comprises also the use of a suspension of inorganic nanoparticles in a liquid medium in which the nanoparticles are bonded to biopolymers, for coating pretreated surfaces of materials. By means of the pre-treatment bonding of the subsequently deposited conjugates to the surfaces is increased.

An aspect of the invention is also the use of a suspension of metal salt nanoparticles or metallic nanoparticles, wherein each particle has a defined ratio of several metallic components or components comprised of metal salts and the nanopartides are bonded to biopolymers.

Advantageously, a multi-phase suspension produced in this way in which the individual nanoparticles in the solution are comprised of a defined ratio of different inorganic components with the same mixing ratio are used in order to generate a uniform distribution of inorganic nanopartides on surfaces of finely divided, high-surface area materials.

Nanoparticle suspensions can be concentrated for increasing the concentration by ultrafiltration. By means of the higher initial concentration of the nanoparticle suspensions produced according to the invention in comparison to the prior art, ultrafiltration can be performed significantly faster and as a result of the reduced filter surface area at reduced costs.

Conventional support materials have a microporosity and mesoporosity that is not accessible when used as a catalyst, but for coating with the catalytic material from solution, as a result of the high diffusion rates of the dissolved precious metal salts and the long exposure times, may lead to a depletion of expensive precious metal resources. The term mesoporosity is to be understood as pore spaces whose size is between 2 and 50 nm. Microporosity means pore spaces whose size is smaller than 2 nm. Even the use of the previously generated nanoparticles in a stable suspension for deposition of the nanoparticles on the catalyst support cannot prevent penetration of precious metal into the pores of the carrier material that are not accessible for the application and thus the loss of its catalytic activity because the diameter of the nanoparticles is usually below the size of the pores.

The use of the suspensions of conjugates of nanoparticles and biopolymers prevents however advantageously penetration of the nanoparticles into the porous interior of catalyst supports because their total diameter, depending on the employed biopolymer, surpasses that of the pores. The conjugates thus effect an almost complete precipitation of catalytically active nanopartides on the surface of the catalyst support where they develop maximum action upon use of the catalyst.

The method according to the invention provides advantageously an extremely uniform dispersion on the metallic, ceramic or polymer materials of the nanopartides that are bonded to biopolymers and that are either metallic or comprised of metal salts. When metallic nanoparticles or nanoparticles comprised of metal salts are deposited from a suspension on the surface of the materials, during the drying process along the drying frontiers significant forces will act that usually lead to local concentrations of the precipitated nanopartides (drying pattern) and significantly reduce the uniformness of distribution of the particles on the surface.

In contrast to this, the nanoparticles produced according to the invention are present as conjugates with a biopolymer. When the support material is incubated with the solution of the conjugates of nanoparticles and biopolymers, adsorption of the conjugates on the support takes place. Without biopolymers, the agglomeration of particles on the surface cannot be prevented with conventional methods that are known from the art. By means of conjugation with a biopolymer, the distribution after the drying process is surprisingly maintained even for nanoparticles with an average diameter smaller than 50 nm. The invention comprises therefore also the finely divided, high-surface area materials coated with nanoparticles and obtainable by the method according to the invention.

In a preferred embodiment of the invention the support material that is coated with the nanoparticles is used for producing a fixed catalyst for heterogeneous catalysis.

In catalysts for heterogeneous catalysis for increasing the catalytically acting surface area and for saving precious catalytically active substances the catalytically active components are often applied onto a support with high surface area. As catalytically active parts in the catalysts according to the invention metallic or metal-oxide nanopartides or nanoparticles comprised of one or several metal salts are used, preferably nanoparticles of an element or an element compound of the platinum metal group or of mixtures or alloys of several elements or element compounds of the platinum metal group, particularly preferred of platinum an/or palladium or their salts.

The method according to the invention can therefore be used for producing such catalysts. In the employed suspensions first nanopartides of metal salts that are conjugated to the biopolymers are produced. In order to arrive at catalytically active metallic or metal oxide nanopartides, it is therefore necessary, in case the metal salt is not an oxide, to perform a reduction step that is carried out either before or after deposition on the finely divided high-surface area support material that is used as a catalyst support. Preferably, the reduction step is carried out after the coating step.

Especially preferred, the catalyst according to the invention is produced in that the support material is first coated from a suspension of biopolymer conjugates with metal salt nanopartides. After coating first a drying step is performed and subsequently a dry reduction with hydrogen gas is performed in which the nanopartides comprised of metal salts are reduced to metallic nanoparticles and, at the same time, the biopolymers are denatured. The removal of biopolymers can be realized alternatively also upon starting up the catalyst (conditioning).

In case of fixed catalysts one differentiates between shaped body, powder and monolith catalysts.

Shaped body catalysts are used primarily in fixed bed reactors and are comprised of ceramic particles that are coated with catalytically active components.

Powder catalysts are used in stirred reactors and fluidized bed reactors. Here a powdery support is coated with the catalytically active material.

In a monolith catalyst, a so-called honeycomb body is coated with a coating suspension (washcoat) that is comprised of a powdery support layer that itself is coated with the catalytically active material. In an alternative method for producing monolithic catalysts, after application of a washcoat without catalytically active metal the monolithic catalyst is impregnated in a metal salt solution.

The method according to the invention is suitable for producing all these catalysts; it is especially advantageously suitable for the production of coating suspensions for monolith catalysts. For this purpose, suitable support materials are coated with the conjugates of nanoparticles and biopolymers by contacting with the suspension according to the present invention and subsequently the honeycomb body is coated with the catalytically coated support materials. According to an advantageous embodiment, the biopolymers after coating can be removed, for example, by heat treatment or by enzymes. The biopolymers can also be denatured as described above as a result of reduction.

Loading the catalyst supports with the nanoparticles according to the invention is usually realized in accordance with the prior art by mixing the support powder with a precious metal solution and precipitation of the metal salts on the support (pore filling method). However, this leads in the methods according to the prior art to the aforementioned problem that, upon deposition of the nanoparticles on the catalyst support the penetration of precious metals into the pores of the support, that are not accessible or only to a minimal proportion accessible for the application, and thus the loss of a catalytic activity cannot be prevented.

Basically, a preparation of metallic nanoparticles as a suspension in solution with subsequent deposition of the particles on the support powder is possible. However, in this case the penetration of precious metals into the pores of the support that are not accessible for the application and thus the loss of their catalytic activity also cannot be prevented because the diameter of the nanoparticles is usually below the size of the pores.

In contrast to this, the conjugates used in accordance with the method according to the present invention effect an almost complete precipitation of the catalytically active nanoparticles on the accessible surface of the catalyst support because their total diameter depending on the employed biopolymer surpasses that of the pores and thus advantageously prevents penetration of nanoparticles into the porous interior of the catalyst support.

The nanoparticle suspensions prepared according to the present invention have no complete surface functionalization, i.e, the surface of the nanopartides remains accessible because the nanoparticles are bonded only at certain sites unspecifically to the biopolymer. As a result of the spatial constellation of the proteins an agglomeration of the particles is however prevented. The proteins employed according to the invention do not hinder the catalytic activity but, if this is necessary, can be removed, for example, thermally or by means of enzymes after deposition of the particles.

The catalysts produced according to the invention have a high activity even though minimal quantities of precious metals are used. The tailored preparation of nanoparticles of defined size and surface properties, particularly however the combination of different nanopartides, enable an increased catalytic activity on surfaces and a high aging resistance in particular at high temperatures because formation of coarser particles as a result of sintering can be reduced.

In principle, such catalysts can be used in the gas phase as well as in the liquid phase. Despite the use of biocomponents the use even at high temperatures is possible because the stabilizing biopolymer is required only during the preparation of the catalyst and after deposition on the support can be removed.

In comparison to a direct deposition of the particles on the support surfaces in certain cases a prior synthesis of the nanoparticles in solution has further advantages because excellent support properties of the catalysis do not necessarily go hand in hand with excellent template properties for the particle deposition. In the use of particles suspension known from the prior art for producing catalysts on supports, the dispersion of the nanoparticles on the support material can however be controlled only badly and leads to high heterogeneity of the distribution. By drying the support layer, the nanopartides become dewetted and drying patterns are formed because of the nanoparticles being bonded to the support materials.

In contrast to this, with the suspensions proposed according to the invention by using biopolymers an excellent distribution of nanoparticles and thus a high catalytic activity with a minimal proportion of catalytically active material is achieved. Also, during drying of the coated material, there is no disturbance of the uniform distribution; the high regularity of the coating is maintained.

The invention comprises therefore also finely divided, high-surface area material that is coated with inorganic nanoparticles from a solution, preferably an aqueous solution, in which the nanoparticles on the surface of the finely divided, high-surface area material do not form insular structures and do not create a drying pattern.

The invention comprises also materials coated with nanoparticles in which the nanoparticles on the surface of the coated material do not form insular structures and drying patterns. These materials are obtainable by deposition from solution of nanoparticles bonded on biopolymers.

Based on the following Figures and examples the invention will be explained in more detail without limiting the invention to the examples. It is shown in:

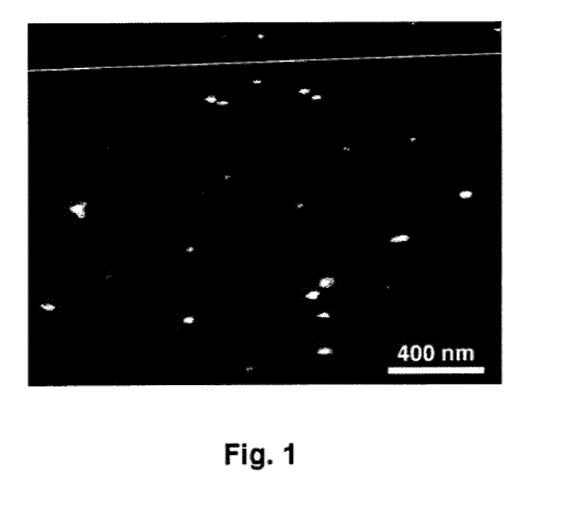

FIG. 1 an SEM image of a nanoparticle suspension that has been formed with protein oligomers.

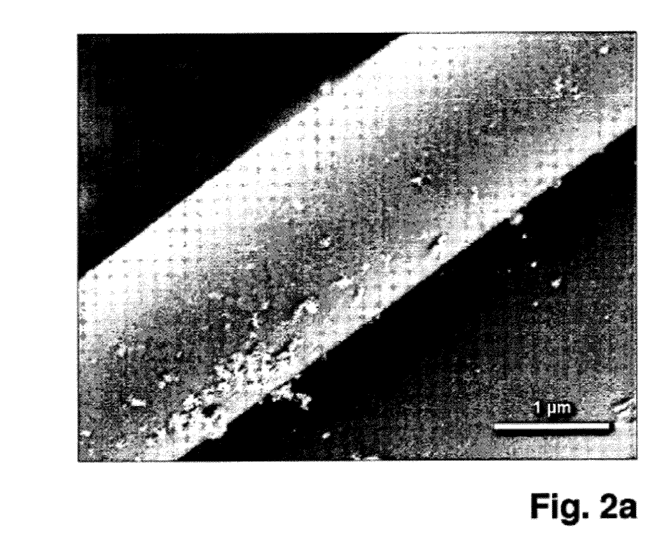

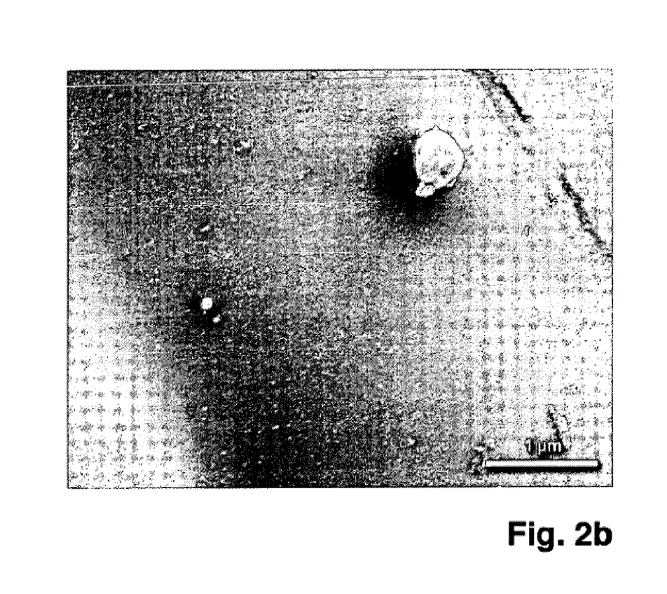

FIG. 2 the homogenous distribution of metallic nanoparticles by use of biotemplate suspensions: a) large agglomerated particles with conventional deposition of ceramic nanoparticles and subsequent reduction; b) homogenous distribution of metallic nanoparticles below the resolving power by use of suspensions on the basis of biotemplates.

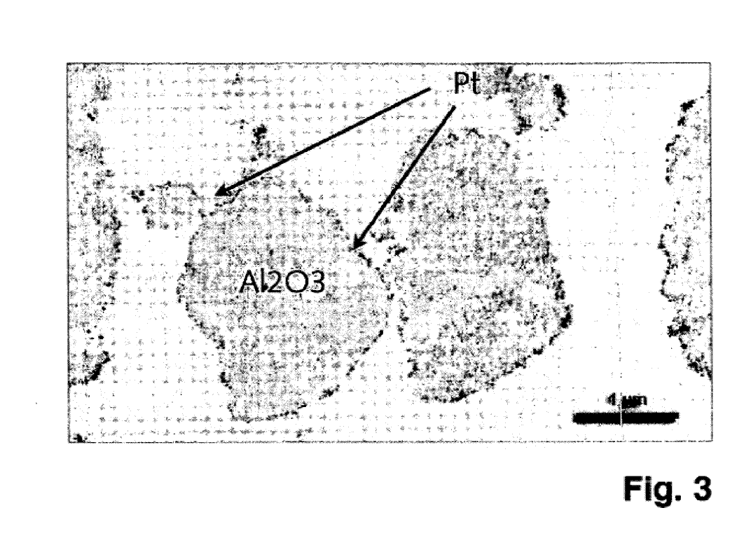

FIG. 3 TEM image of a cross-section of an Al₂O₃ support particle (70 nm thickness). Avoiding of penetration of precious metals into the particle volume.

### EXAMPLE 1

Preparation of a Stable Pt(NO₃)₂ Complex Solution by Employing Bovine Serum Albumin.

Produced is an aqueous solution with 3 mmol/IPt(NO₃)₂.

30 μl of the aqueous BSA solution (parent solution) produced with 20 g/l are incubated with 3 ml of the platinum solution for 30 min. In this connection, an intensive mixing of components must be ensured. The complete and homogeneous mixture of the components is realized by means of vortex mixing.

### EXAMPLE 2

Preparation of a Stable Complex Solution as Described in Example 1 but with use of H₂Pt(OH)₆ (14.44%) Sissolved in Ethanol Amine.

In this method, in analogy to Example 1, a stable suspension by using BSA is generated. The concentration of the H₂Pt(OH)₆ solution is here 3 mmol/l wherein the dilution is done with distilled water.

In contrast to the BSA parent solution employed in Example 1 the concentration of the BSA parent solution is 2.5 g/l so that a reduced ratio between protein and platinum in comparison to Example 1 exists.

To 30 μl of the parent solution BSA are added 3 ml of the platinum solution and reacted for 30 min., wherein again an intensive mixing of the solutions must be ensured.

### EXAMPLE 3

Preparation of a Stable Complex Solution as Described Under Example 1, but by using Pd(NO₃)₂.

In this method, in analogy to Example 1, a stable suspension by using BSA is generated.

30 μl of the aqueous BSA solution (parent solution) produced with 20 g/l are incubated with 3 ml of the palladium solution for 30 min. An intensive mixing of the components must be ensured. The complete and homogeneous mixing of the components is achieved in this connection by vortex mixing.

### EXAMPLE 4

Preparation of a Stable Bimetallic Complex Solution by using Pd(NO₃)₂ and H₂Pt(OH)₆.

To 300 μl 20 g/l BSA solution at the same pH value, 1.5 ml 3.9 mmol H₂Pt(OH)₆ and Pd(NO₃)₂ solution are added, respectively, vortex-mixed, and incubated for 30 min.

Since the thus produced nanoparticles have not been produced by a precipitation reaction but by bonding on protein, the metal salts palladium nitrate and palladium hydroxide are present in a constant ratio of 1:1.

### EXAMPLE 5

Preparation of a Stable Platinum Sol by using Bovine Serum Albumin (BSA) as a Stabilizing Reagent and Pt(NO₃)₂.

First, a stable Pt(NO₃)₂ solution according to Example 1 is produced.

After termination of the interaction time between biological material and platinum salt solution, the reducing agent is added immediately, i.e., 1.5 ml of a freshly produced aqueous 0.1 mol/l NaBH₄ solution. In order to ensure a complete reduction to metallic platinum, the reducing agent is left in the solution for 2 h. Subsequently, impurities are removed from the product by dialysis.

This purification step is done by using dialysis chambers or dialysis hoses with exclusion limits of 10 kDa and a dialysis duration of 4 h. For storage of the platinum particles the suspension is subsequently directly sterile-filtered into the storage containers. For this purpose, a microfilter with a pore width of 0.2 μm is used.

FIG. 1 shows a scanning electron microscope image of the thus produced suspension of platinum particles whose dimensions are approximately at 18 nm.

The thus produced suspension was stable for more than 2 months without sedimentation effects being observed.

### EXAMPLE 6

### Preparation of a Stable Platinum Sol as Described in Connection with Example 5, but by using H₂Pt(OH)₆ (14.44%) Dissolved in Ethanol Amine

First, a stable H₂Pt(OH)₆ solution according to Example 2 is prepared.

At the end of the incubation time, by using 1.5 ml of the reducing agent NaBH₄ (0.1 mol/l) in a reaction time of 2 hours platinum particles are generated that, after dialysis and sterile filtration, are available for further processing.

The concentration of the particles, based on the employed quantities, is 0.39 g/l. The measurement of the particle size by means of dynamic light scattering results in a value of 18 nm.

The thus produced suspension was stable for more than 2 months without exhibiting sedimentation effects.

### EXAMPLE 7

### Preparation of a Stable Silver Sol by using Bovine Serum Albumin (BSA) as a Stabilizing Reagent and Ag(NO₃)₂

By means of the method disclosed in the preceding text also other colloidal precious metal solutions can be prepared instead of the platinum particles. One possibility is the preparation of silver particles in solution by means of stabilization by the biologic component BSA.

For this purpose, in accordance with the preceding examples, to 30 μl of a BSA parent solution, c=10 g/l, 3 ml of a 2 mmol/l aqueous Ag(NO₃)₂ solution are added, intensively mixed, reacted for 30 min., and reduced with 1.5 ml of the reducing agent NaBH₄ (0.1 mol/l) and a reaction time of 2 h.

For purification and further storage of the suspensions dialysis and sterile filtration follow in analogy to the aforementioned embodiments.

The color of the synthetic suspension indicates that the size of the Ag nanoparticles is in the range of less than 100 nm. The concentration of the Ag particles results, based on the employed quantities, in 0.14 mg/l.

The thus produced silver sol was stable without sedimentation for more than 3 months.

### EXAMPLE 8

### Preparation of Finely Divided High-Surface Area Support Material Coated with Ceramic Nanoparticles

A nanoparticle suspension according to Examples 1 to 2 is applied onto suitable aluminum oxide powder that serves as a substrate.

First, 25 g of Al₂O₃ are mixed with 250 ml of 10% APTES solution. The sample was incubated for 2 days at room temperature in a rotary incubator and then rinsed with acetone. After separation of the acetone the sample is subjected to evaporation for 3 hours under a hood.

For adsorption of the platinum particles on the substrate (gamma-Al₂O₃ powder, average particle size 11 μm, average BET surface area 169 m²/g) 640 ml of a ready-made solution according to Examples 1 to 2 was applied to 25 g of the substrate and with agitation incubated for 24 h at room temperature with agitation. Because of the biopolymers the particles, despite the strong bonding to the substrate, remain. The ceramic nanoparticles of a size of less than 2 nm exhibit a uniform distribution on the surface even after drying. An insular pattern by drying frontiers cannot be observed.

### EXAMPLE 9

### Preparation of a Fiber-Like, Finely Divided, High-Surface Area Support Material Coated with Metallic Nanoparticles by use of a Nanopartide Suspension of Metal Salts and Subsequent Reduction

2 g of the purified Al₂O₃ fibers are placed into a 50 ml tube and subsequently 20 ml of 10% APTES solution is placed on top. The samples are incubated for 2 days at room temperature. Subsequently, the APTES solution is carefully removed and acetone placed on top. After separation of acetone the samples are subjected to evaporation for approximately 3 h under a hood.

For adsorption of the platinum particles on the Al₂O₃ fibers 4 ml of a ready-made solution according to the Examples 1 to 2 are added to 2 g substrate and incubated with agitation at room temperature for 24 hours with agitation.

Subsequent to the incubation of the nanoparticles on the aluminum oxide support, reduction by addition of freshly prepared aqueous 0.1 mol/l NaBH₄ solution is carried out or, alternatively, after drying by allowing hydrogen to flow across at 200° C.

The thus obtained metallic nanoparticles of the fiber surfaces are very small and are thus below the resolving power of conventional scanning electron microscopes (FIG. 2b). In case of nanoparticles obtained by conventional precipitation of metal salts on the fibers and subsequent wet-chemical reduction, the formation,of drying patterns leads to a significant enlargement of the particles (FIG. 2a).

### EXAMPLE 10

### Preparation of a Finely Divided, High-Surface Area Powdery Support Material Coated with Metallic Nanoparticles by the use of a Metallic Nanoparticle Suspension

The preparation of the Al₂O₃ powder is realized according to Example 8. A nanoparticle suspension according to Examples 5 to 6 is applied onto a suitable aluminum oxide powder that serves as a substrate. For adsorption of the platinum particles on the substrate (gamma-Al₂O₃ powder, average particle size 11 μm, average BET surface area 169 m²/g), 640 ml of a ready-made solution according to Examples 5 to 6 are placed onto 25 g substrate and under agitation for 24 h at the room temperature incubated with agitation.

After cutting individual particles of the Al₂O₃ powder in a thickness of approximately 70 nm and analysis under a transmission electron microscope it can be proven that the metallic nanoparticles have not penetrated into the interior of the powder particles (FIG. 3).

### EXAMPLE 11

### Preparation of a Finely Divided, High-Surface Area Support Material Coated with Nanoparticles, Wherein the Nanoparticles are Comprised of a Mixture of Two Metal Salts

The preparation of the nanopartide suspension of two metal salts was realized in accordance with Example 4. The precipitation of the nanopartides on an aluminum oxide surface is realized in accordance with Example 8.

The nanoscale structures have under thermal load a high sintering stability.

### EXAMPLE 12

### Preparation of a Finely Divided, High-Surface Area Support Material Coated with Bimetallic Nanoparticles

First, the preparation of a finely divided, high-surface area support material coated with nanoparticles of two metal salts is realized in accordance with Example 11. Subsequently, a reduction is carried out with 0.1 molar NaBH₄ solution or after drying by passing across hydrogen at 200° C.

The uniformly distributed bimetallic particles have a constant ratio of platinum and palladium in a ratio of 1:1.

### EXAMPLE 13

### Coating of Nanoparticles with a Silicon Layer

First a stable suspension according to Example 5 is produced.

Parallel to this, cation exchange resin by incubation in 10-fold quantity of 5% HCl solution is converted to the H+form and subsequently rinsed with 100-time quantity of distilled water. An aqueous 0.54% sodium silicate solution is then brought to pH 10 by stepwise addition of prepared acidic cation exchanger and thus activated.

200 ml of the suspension produced according to Example 6 are mixed with intensive stirring with 2.5 ml of an aqueous 1 mmol 3-aminopropyl trimethoxy silane solution. After incubation for 15 min. under intensive stirring, 20 ml of the activated silicate solution are added.

Based on this treatment, a silicon shell is formed that increases the sintering stability of the produced precious metal particles after coating on a substrate and bonding of the particles to the different substrates is improved.

The solution is allowed to rest for 24 hours. Stopping of the silicate deposition is realized subsequently by 24-hour dialysis (dialysis membrane 14 kDa) against the 1,000-fold quantity of distilled water.

### EXAMPLE 14

### Preparation of a Stable Platinum Sol by using Non-Recrystallized S-Layers as Stabilizing Reagent and Pt(NO₃)₂.

A freshly harvested culture of Bacillus sphaericus NCTC9602 is concentrated to a dry biomass contents of 30 g/l. 10 ml of this biomass concentrate are incubated with 20 ml of aqueous 3-molar MgCl₂ solution for 10 min. at room temperature with light agitation. Subsequently, the solution is centrifuged at 20,000 g for 20 min. at 4° C. The centrifugation supernatant is dialyzed for 24 h against 10 liters of distilled water at 4° C. wherein the exclusion limit of the dialysis membrane should be 14 kDa. The dialysis product is again centrifuged at 20,000 g for 20 min. at 4° C. and the pellet is disposed of.

To 1 ml of the supernatant is added 15 ml of an aqueous 3 mmol/l Pt(NO₃)₂ solution followed by incubation for 30 min. An intensive mixing of the components must be ensured. The complete and homogenous mixing of the components is realized by vortex-mixing. To this mixture is then added 8 ml of freshly produced aqueous NaBH₄ solution (0.1 mol/l) and brief mixing by means of a vortex-mixer. An incubation time of 2 h follows in which the reduction to metallic particles is realized.

What is claimed is:

1.-46. (canceled)

47. A method for producing finely divided, high-surface area materials coated with inorganic nanoparticles, comprising the steps of:
coating a finely divided, high-surface area material with inorganic nanoparticles bonded to biopolymers by contacting the finely divided, high-surface area material with a liquid medium suspension of the inorganic nanoparticles bonded to biopolymers;
optionally, drying the coated finely divided, high-surface area material.

48. The method according to claim 47, comprising the step of selecting at least one of the nanoparticles from the group consisting of metallic nanoparticles, metal-oxidic nanoparticels, and nanoparticulate metal salts.

49. The method according to claim 47, comprising the step of selecting at least one of the nanoparticles from the group consisting of an element of the platinum metal group, a compound of an element of the platinum metal group, a mixture of several elements of the platinum metal group, a mixture of several compounds of an element of the platinum metal group, an alloy of several elements of the platinum metal group, and an alloy of several compounds of an element of the platinum metal group.

50. The method according to claim 47, comprising the step of selecting at least one of the nanoparticles from the group consisting of platinum, palladium, platinum salts, and palladium salts.

51. The method according to claim 47, comprising the step of reducing the nanoparticles to metallic nanoparticles after the step of coating.

52. The method according to claim 47, comprising the step of reducing by a dry reduction with hydrogen gas the nanoparticles to metallic nanoparticles after the step of coating.

53. The method according to claim 47, comprising the step of selecting the biopolymer from the group of proteins consisting of human serum albumin (HSA), prealbumin, lactalbumin, conalbumin, ovalbumin, parvalbumin, transferrin, bovine serum albumin (BSA), and non-recrystallizable S-layer protein.

54. The method according to claim 47, comprising the step of removing the biopolymers after the step of coating while the nanoparticles remain on the finely divided, high-surface area material.

55. The method according to claim 47, comprising, after the step of coating, the step of reducing the nanopartides to metallic nanoparticles under conditions that are incompatible for the biopolymers causing denaturing of the biopolymers.

56. The method according to claim 47, wherein the suspension is prepared by incubation of the biopolymers with a salt solution selected from an aqueous solution of AgNO₃, (CH₃COO)₂Pd, Pt(NO₃)₂, H₂(Pt(OH)₆, or K₂PtCl₄ or mixtures thereof.

57. The method according to claim 47, further comprising the step of selecting the finely divided, high-surface area material from the group consisting of aluminum oxides, aluminum silicates, zeolites, silicon dioxide, titanium oxide, zirconium oxide and cerium oxide, their mixtures, and their mixed oxides.

58. The method according to claim 47, wherein the finely divided, high-surface area material is a support material suitable as a fixed catalyst.

59. The method according to claim 47, wherein the finely divided, high-surface area material is a support material suitable as a monolith catalyst, further comprising the step of coating honeycomb bodies of monolith catalysts with the finely divided, high-surface area material that is coated with the inorganic nanoparticles.

60. A finely divided, high-surface area material coated with nanoparticles made by the method of claim 47, wherein the nanoparticles do not form insular structures and do not create a drying pattern on a surface of the finely divided, high-surface area material.

61. A catalyst for heterogeneous catalysis comprising a finely divided, high-surface area support material and a catalytically active layer, the catalyst made by the steps of:
coating a finely divided, high-surface area support material with inorganic nanoparticles bonded to biopolymers by contacting the finely divided, high-surface area support material with a liquid medium suspension of the inorganic nanoparticles bonded to biopolymers;
optionally, drying the coated finely divided, high-surface area support material.

62. The catalyst according to claim 61, wherein the nanoparticles are selected from the group consisting of metallic nanoparticles, metal-oxidic nanoparticels, and nanoparticulate metal salts.

63. The catalyst according to claim 61, wherein the nanoparticles are selected from the group consisting of an element of the platinum metal group, a compound of an element of the platinum metal group, a mixture of several elements of the platinum metal group, a mixture of several compounds of an element of the platinum metal group, an alloy of several elements of the platinum metal group, and an alloy of several compounds of an element of the platinum metal group.

64. The catalyst according to claim 61, wherein the nanoparticles are selected from the group consisting of platinum, palladium, platinum salts, and palladium salts.

65. The catalyst according to claim 61, wherein the nanoparticles are reduced to metallic nanoparticles after the step of coating.

66. The catalyst according to claim 65, wherein the nanoparticles are reduced during conditioning of the catalyst.

67. The catalyst according to claim 61, wherein the biopolymer is a protein selected from the group consisting of human serum albumin (HSA), prealbumin, lactalbumin, conalbumin, ovalbumin, parvalbumin, transferrin, bovine serum albumin (BSA), and non-recrystallizable S-layer protein.

68. The catalyst according to claim 61, wherein the biopolymers are removed after coating and the nanopartides remain on the finely divided, high-surface area support material.

69. The catalyst according to claim 61, wherein after coating the nanoparticles are reduced to metallic nanoparticles under conditions that are incompatible for the biopolymers causing denaruring of the biopolymers.
